(19) United States
(12) Patent Application Publication
(10) Pub. No.: US 2006/0143857 A1
(43) Pub. Date: Jul. 6, 2006

(54) Handle for the door of a vehicle

(76) Inventors: Uwe Freyholdt, Giengen (DE); Michael Geber, Bad Urach (DE); Martin Lindmayer, Sulz (DE); Andreas Pohlmann, Weil der Stadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/536,785

(22) PCT Filed: Sep. 24, 2003
(86) PCT No.: PCT/EP03/10608

§ 371 Date: Oct. 21, 2005

(30) Foreign Application Priority Data
Nov. 28, 2002 (DE) 10255439.0

(51) Int. Cl. E05B 1/00

(52) U.S. Cl. 16/110.1; 340/426.28

(57) ABSTRACT

A handle arrangement for a vehicle door with a door handle mounted on its outside and a capacitive locking sensor arranged in the region of the door handle which is remote from the door has a capacitive sensor for a convenience closing function additionally provided in the region of the door handle which is remote from the door. These measures provide a user with a convenient and safe way of locking the vehicle and closing all vehicle openings.

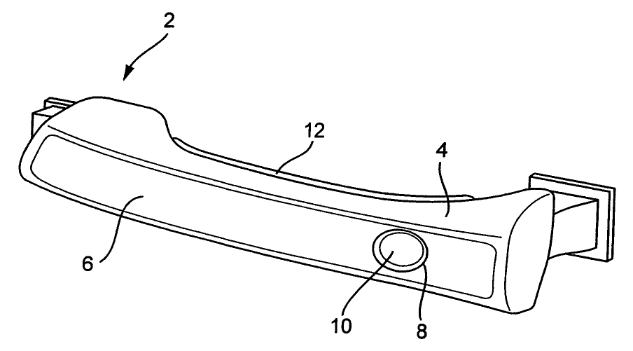

### BACKGROUND AND SUMMARY OF THE INVENTION

This invention relates to a handle arrangement for a vehicle door.

A particular point for attention in the development of vehicles is the operation and functionality of vehicle access apparatuses, particularly handle arrangements.

German document DE 196 17 038 C2 discloses a closing system for a motor vehicle with a lock which can be operated using a handle. An outer shell of the handle contains a pushbutton switch, which allows the closing system to be locked by operating the pushbutton switch. A drawback is the less than optimum operating ergonomics of the pushbutton switch and the imprecise switching point position thereof. The pushbutton switch may also be replaced by a tactile sensor which senses a person's desire to secure the vehicle through his hand being passed in front of the side of the handle which is remote from the vehicle.

Besides a locking function, a convenience closing function is also used in the applicant's vehicles. The convenience closing function brings about automatic locking of all vehicle doors and closure of all further vehicle doors which are open. Examples of vehicle openings are windows, sunroofs and convertible tops, in particular. The convenience locking function can be activated by pressing a closing key on a remote control for the closing system for a long time, for example.

In addition, German document DE 198 05 659 C1 describes an apparatus for initiating an authorization request for a vehicle, where a first switching means for locking a vehicle door is positioned in a depression in a door handle such that its control button is arranged so as to be slightly depressed relative to the surface of the door handle in the unoperated state. The fact that it is accommodated in a depressed position means that the switching means is largely protected against external influences, such as freezing or deliberate damage. The switching means used may preferably be switches which have no quiescent current at all or just a small quiescent current. Besides reed switches, capacitive switches, mechanical microswitches or magnetic switches are also conceivable.

The invention thus has as one object the object of providing a handle arrangement for a vehicle door with a door handle mounted on its outside and a capacitive locking sensor arranged in the region of the door handle which is remote from the door, in which the handle arrangement provides a user with a convenient and safe way of locking and closing all vehicle openings in the vehicle.

This object is achieved by a handle arrangement for a vehicle door having the features claimed.

In accordance with the invention, a capacitive sensor for a convenience closing function is provided in addition to the capacitive locking sensor in the region of the door handle which is remote from the door. Having been touched, the capacitive sensor for the convenience closing function automatically locks all vehicle doors and closes all further vehicle openings that are open.

The convenience closing function is activated only when the capacitive sensor for the convenience closing function is touched; otherwise the convenience closing function is immediately interrupted and deactivated. Only when a user deliberately operates the capacitive sensor for the convenience closing function will it be activated, since a convenience closing function which is not monitored by the user may possibly result in misoperation. A capacitive locking sensor which is likewise arranged in the region of the door handle which is remote from the door locks the vehicle doors when it is briefly touched by the hand. A convenience closing function is not activated with it. The capacitive locking sensor is used when the vehicle is briefly left, for example, with the user staying in range of the vehicle and door windows not needing to be closed. Simultaneous activation of both capacitive sensors results only in the vehicle being locked, with the convenience closing function not being activated. This handle arrangement provides the user with a convenient and safe way of locking the vehicle.

In one refinement, the capacitive sensor for the convenience closing function is at least partially surrounded by the sensitive region of the capacitive locking sensor. This arranges the control elements for locking the vehicle in a manner which is extremely convenient and user-friendly for the user. Both capacitive sensors are integrated in two dimensions and therefore provide the user with the feeling of a functional relationship.

In this context, one advantage is that the capacitive sensor for the convenience closing function is arranged in a hollow-like depression in the door handle. Inadvertent, unconscious operation of the capacitive sensor for the convenience closing function is virtually ruled out as a result. In addition, its sensing region is smaller than the sensing region of the capacitive locking sensor. It should normally be able to be operated only through deliberate finger pressure from the user. This makes conscious operation of the convenience closing function a necessity.

Further advantageous refinements of the invention are covered in dependent claims.

### BRIEF DESCRIPTION OF THE DRAWING

The invention is explained in more detail using a plurality of exemplary embodiments described in connection with the single drawing FIGURE showing a detail from a handle arrangement for a vehicle door in a perspective view.

### DETAILED DESCRIPTION OF THE INVENTION

A handle arrangement 2 for a vehicle door (not shown further) comprises a door handle 4 mounted on its outside and a capacitive locking sensor 6 arranged in the region of the door handle 4 which is remote from the door. The locking sensor 6 takes up a large part of the area of the region of the door handle 4 which is remote from the door. Briefly touching the capacitive locking sensor 6 with the hand locks all doors and a trunk lid on the vehicle.

In addition, the region of the door handle 4 which is remote from the door contains a capacitive sensor 8 for a convenience closing function. Having been touched, the capacitive sensor 8 for the convenience closing function likewise automatically locks all vehicle doors, and thus also comprises the locking function of the capacitive locking sensor 6, and additionally closes further vehicle openings that are open, particularly windows, sunroofs and convertible tops. In this exemplary embodiment, the capacitive sensor 8 for the convenience closing function is completely surrounded by the sensitive region of the capacitive locking sensor 6. To avoid misoperation, the capacitive locking sensor 6 and the capacitive sensor 8 for the convenience closing function are in a form such that their sensitive regions are clearly indicated by the geometric shaping and can thus be felt and seen by a user. This integrated or uniform refinement of the two capacitive sensors 6, 8 reinforces the functional relationship in the mode of action of the two capacitive sensors 6, 8. In exemplary embodiments which are not shown further, the capacitive sensor 8 for the convenience closing function may also be surrounded only partly by the sensitive region of the capacitive locking sensor 6. By way of example, it is embedded between two subregions of the capacitive locking sensor 6, or the locking sensor 6 and the capacitive sensor 8 for the convenience closing function are arranged next to one another.

The capacitive sensor 8 for the convenience closing function is arranged in a hollow-like depression 10 in the door handle 4 in the present embodiment. Its depressed positioning means that the capacitive sensor 8 is protected against unconscious and unwanted operation by the user. Alternatively, in an exemplary embodiment which is not shown further, its sensitive region may be in one plane with the sensitive region of the capacitive locking sensor 6.

The convenience closing function can be activated by touching the capacitive sensor 8 for at least a prescribed period. This makes it even more difficult to initiate the convenience closing function inadvertently.

When opening the vehicle, the sensor 8 can also be used to initiate a convenience opening function which, by way of example, allows the user to open the vehicle door with only a small amount of applied force. It is also possible to activate other vehicle functions which make getting in or starting up more convenient. Examples mentioned here are merely the activation of an air-conditioning control system, particularly a seat air-conditioning control system, or the opening of a sunroof. It is likewise conceivable for lighting apparatuses to be turned on in the interior or on the exterior of a motor vehicle on the basis of further parameters such as time of day or ambient lighting.

In addition, an unlocking sensor 12 may be provided in the door-side region of the door handle 4. This may be in the form of a capacitive sensor, a Hall sensor, or a sensor with a reed contact. In the applicant's vehicles, an electronic driving authorization system called KEYLESS-GO is used which operates without a mechanical key. Its identification function is performed by a thin chip card in the format of a conventional EC card or credit card. The advantage is that car drivers need to pick up neither a key nor a card before getting in—the key or card can always remain in the shirt or jacket pocket. As soon as the driver touches the unlocking sensor 12 in the door handle 4, his chip card receives signals from inductive antennas which are accommodated in the doors and in the rear bumper of the vehicle. Electronics which sense the change in the capacitance and translate it into a command pulse are held in space-saving fashion in the door handle 4. The command pulse produced by these electronics initiates the data storage medium check in the electric control unit. The card then sends an identification code to the vehicle by radio. If this code matches the stored value, the card holder can immediately get in or open the trunk lid. The inductive data transfer takes only a few fractions of a second.

To secure the vehicle after getting out, it suffices to pass the hand over the locking sensor 6 or to operate the capacitive sensor 8 for the convenience locking function in deliberate fashion in order to activate the inductive antennas. The system immediately interchanges data with the chip card again, which are stored for later unlocking, and then secures the vehicle.

In connection with KEYLESS-GO, an improvement in the locking and unlocking procedure for the individual vehicle doors and for the trunk lid is achieved. There is no longer any operation using visible switches. Merely operating the door handle 4 when the vehicle is locked unlocks the vehicle, and passing the hand over the sensing exterior of the door handle 4 locks it, with the inventive refinement additionally having the option of the convenience closing function. This additionally increases user-friendliness.

1-5. (canceled)

6. A handle arrangement for a vehicle door with a door handle mounted on its outside comprising:
a first capacitive locking sensor arranged in a region of the door handle which is remote from the door, and
a second capacitive sensor for a convenience closing function which is additionally provided in the region of the door handle which is remote from the door.

7. The handle arrangement as claimed in claim 6, wherein the second capacitive sensor for the convenience closing function is at least partially surrounded by a sensitive region of the first capacitive locking sensor.

8. The handle arrangement as claimed in claim 6, wherein the second capacitive sensor for the convenience closing function is arranged in a hollow-like depression in the door handle.

9. The handle arrangement as claimed in claim 6, wherein the convenience closing function can be activated by touching the second capacitive sensor for at least a prescribed period.

10. The handle arrangement as claimed in claim 6, and further comprising an unlocking sensor provided in a door-side region of the door handle.

11. The handle arrangement as claimed in claim 7, wherein the second capacitive sensor for the convenience closing function is arranged in a hollow-like depression in the door handle.

12. The handle arrangement as claimed in claim 7, wherein the convenience closing function can be activated by touching the second capacitive sensor for at least a prescribed period.

13. The handle arrangement as claimed in claim 8, wherein the convenience closing function can be activated by touching the second capacitive sensor for at least a prescribed period.

14. The handle arrangement as claimed in claim 7, and further comprising an unlocking sensor provided in a door-side region of the door handle.

15. The handle arrangement as claimed in claim 8, and further comprising an unlocking sensor provided in a door-side region of the door handle.

16. The handle arrangement as claimed in claim 9, and further comprising an unlocking sensor provided in a door-side region of the door handle.

17. The handle arrangement as claimed in claim 11, and further comprising an unlocking sensor provided in a door-side region of the door handle.

18. The handle arrangement as claimed in claim 12, and further comprising an unlocking sensor provided in a door-side region of the door handle.

19. The handle arrangement as claimed in claim 13, and further comprising an unlocking sensor provided in a door-side region of the door handle.
